(19) United States
(12) Patent Application Publication
(10) Pub. No.: US 2023/0283888 A1
(43) Pub. Date: Sep. 7, 2023

(54) PROCESSING METHOD AND ELECTRONIC DEVICE

(71) Applicant: Lenovo (Beijing) Limited, Beijing (CN)

(72) Inventors: Yan MA, Beijing (CN); Hai YU, Beijing (CN)

(21) Appl. No.: 18/176,884

(22) Filed: Mar. 1, 2023

(30) Foreign Application Priority Data
Mar. 1, 2022 (CN) 202210194913.6

(51) Int. Cl. H04N 23/60; H04N 23/667; H04R 1/40; H04R 3/00; H04N 23/90

(52) U.S. Cl. CPC H04N 23/64; H04N 23/667; H04N 23/90; H04R 1/406; H04R 3/005

(57) ABSTRACT

A processing method applied to a first electronic device, the method including obtaining first audio data and/or first image data; performing at least one process on the first audio data and/or the first image data to obtain target data to be outputted; and outputting the target data to be outputted to a target application running on a second electronic device having a communication connection with the first electronic device. The target application is configured to directly output the target data to be outputted. The data size of the target data to be outputted is different from data size of the first audio data and/or the first image data.

### CROSS-REFERENCES TO RELATED APPLICATION

This application claims priority to Chinese Patent Application No. 202210194913.6 filed on Mar. 1, 2022, the entire content of which is incorporated herein by reference.

### FIELD OF TECHNOLOGY

The present disclosure relates to the technical field of electronic devices and, more specifically, to a processing method and an electronic device.

### BACKGROUND

The application of remote video conferencing is becoming more popular, especially with the outbreak of the pandemic and the coming of the post-pandemic era, this demand is becoming more urgent. In general, a desktop terminal, multiple cameras, multiple audio devices, and a control device need to be set up in the conference room. The collected video stream and audio stream area generally independently transmitted to the cloud, through which image and audio processing are performed independently, and then re-transmitted to each terminal device. This process is costly, the maintenance is high, and video fusion cannot be realized. Further, this process is highly dependent on the image and audio processing capabilities of the service provider, which tends to be poor.

### BRIEF SUMMARY OF THE DISCLOSURE

One aspect of the present disclosure provides a processing method. The processing method includes obtaining first audio data and/or first image data; performing at least one process on the first audio data and/or the first image data to obtain target data to be outputted; and transmitting the target data to be outputted to a target application running on a second electronic device having a communication connection with the first electronic device, the target application being configured to directly output the target data to be outputted, where the data size of the target data to be outputted is different from the data size of the first audio data and/or the first image data.

Another aspect of the present disclosure provides an electronic device. The electronic device includes a body; a microphone array arranged on the body for collecting audio data in a target space environment; a camera array arranged on the body for collecting image data in the target space environment; and a processing disposed in the body. The processing device is configured to obtain first audio data and/or first image data, the first audio data including or not including the audio data collected by the microphone array, the first image data including or not including the image data collected by the camera array; perform at least one process on the first audio data and/or the first image data to obtain target data to be outputted, data size of the target data to be outputted being different from data size of the first audio data and/or the first image data; and transmit the target data to be outputted to a target application running on a second electronic device having a communication connection with the electronic device, the target application being configured to at directly output the target data to be outputted.

Another aspect of the present disclosure provides a processing device. The processing device includes an acquisition module configured to obtain first audio data and/or first image data; a processing module configured to perform at least one process on the first audio data and/or the first image data to obtain target data to be outputted; and an output module transmitting the target data to be outputted to a target application running on a second electronic device having a communication connection with the electronic device, the target application being configured to directly output the target data to be outputted, where the data size of the target data to be outputted is different from the data size of the first audio data and/or the first image data.

### BRIEF DESCRIPTION OF THE DRAWINGS

To more clearly illustrate the technical solution in the present disclosure, the accompanying drawings used in the description of the disclosed embodiments are briefly described hereinafter. The drawings are not necessarily drawn to scale. Similar drawing labels in different drawings refer to similar components. Similar drawing labels with different letter suffixes refer to different examples of similar components. The drawings described below are merely some embodiments of the present disclosure. Other drawings may be derived from such drawings by a person with ordinary skill in the art without creative efforts and may be encompassed in the present disclosure.

FIG. 1 is a flowchart of a processing method according to an embodiment of the present disclosure.

FIG. 2 is a side view of a first electronic device.

FIG. 3 is a top view of an imaging range of each camera in a camera array.

FIG. 4 is a planar expansion view of the imaging range of each camera in the camera array.

FIG. 5 is a flowchart of an implementation of a process at 120.

FIG. 6 is a flowchart of another implementation of the process at 120.

FIG. 7 is a flowchart of another implementation of the process at 120.

FIG. 8 is a flowchart of another implementation of the process at 120.

FIG. 9 is a structural block diagram of a processing device according to an embodiment of the present disclosure.

### DETAILED DESCRIPTION

Hereinafter, aspects, features, and embodiments of the present disclosure will be described with reference to the accompanying drawings. It should be understood that such description is illustrative only but is not intended to limit the scope of the present disclosure. In addition, it will be understood by those skilled in the art that various modifications in form and details may be made therein without departing from the spirit and scope of the present disclosure.

It should be understood that although the present application has been described with reference the specific embodiments, many other equivalents of the present disclosure may be implemented by those skilled in the art with features of the claims of the present disclosure, and are therefore within the scope of protection defined herein.

Embodiments of the present disclosure are described hereinafter with reference to the accompanying drawings. However, it should be understood that these embodiments are merely examples of the present disclosure, which may be implemented in various ways. Well-known and/or repetitive functions or structures are not described in detail in order to clarify the true intent based on a user’s operation history, and avoid unnecessary details that may obscure the present disclosure. Therefore, the specific structural and functional details of the present disclosure are not intended to be limiting, but are merely used as the representative basis of the claims to teach those skilled in the art to use the present disclosure in virtually any suitable and detailed structure.

In the specification, terms such as “in one embodiment”, “in another embodiment”, “in an additional embodiment”, or “in other embodiments” may all refer to one or more the same or different embodiments of the present disclosure.

Embodiments of the present disclosure provide a processing method, which can be applied to a first electronic device for processing audio data and/or video data, compressing data size or integrating data, such as performing video fusion, to form target data to be outputted that can be directly output by a target application on a terminal device participating in a video conference, thereby reducing the reliance on cloud or server-side data processing capabilities and improving the smoothness of video conferencing.

The first electronic device can be in various forms, which may include, but is not limited to, smartphones, tablet computers, notebook computers, and conference machines dedicated to video conferencing. The device type and specific structure of the first electronic device are not limited in the present disclosure.

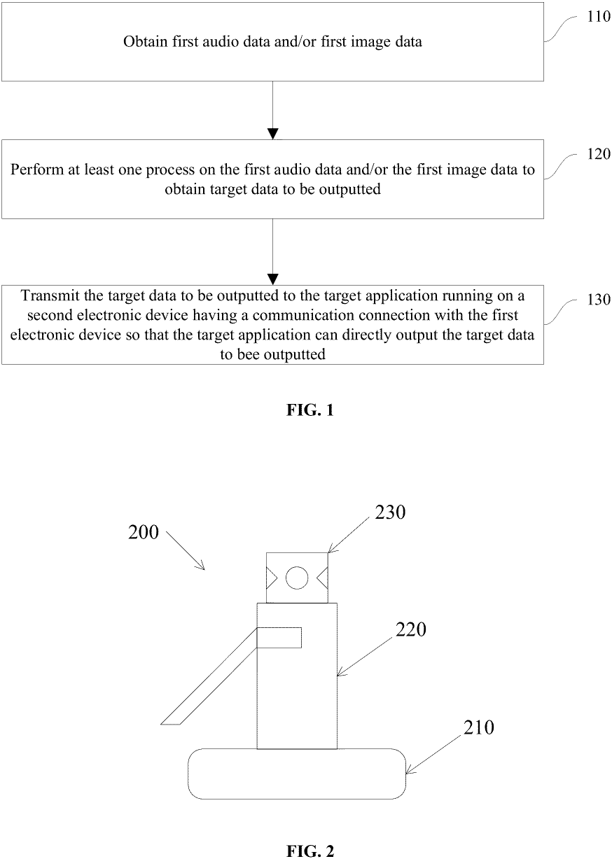

FIG. 1 is a flowchart of a processing method according to an embodiment of the present disclosure. The processing method will be described in detail below.

110, obtaining first audio data and/or first image data.

The first audio data and the first image data may be data collected by the first electronic device itself, or data collected by other electronic devices.

In some embodiments, only the first audio data may be obtained. For example, if the terminal device participating in the meeting only has an audio collection device, or if it is inconvenient for the participants to share their images, only the audio collection of the terminal device may be turned on to collect the audio data.

In some embodiments, only the first image data may be obtained. For example, only the first image data may be collected when the participants did not speak.

In some embodiments, the first audio data and the first image data may be obtained simultaneously. For example, the audio data and the image data of one or more meeting places may be collected by the image collection device and the audio collection device.

120, performing at least one process on the first audio data and/or the first image data to obtain target data to be outputted.

There are two basic requirements for the target data to be outputted. One requirement may be that the data size of the target data to be outputted is less than the data size of the first audio data and/or the first image data. In this way, the occupancy of communication bandwidth can be reduced. For example, in the case where multiple terminals need to upload audio and/or image data at the same time in the same local area network, the technical solution of the present disclosure can greatly reduce the amount of data to be uploaded. In other embodiments, the data size of the target data to be outputted may also be greater than the data size of the first audio data and/or the first image data, such as when video super-resolution, video enhancement, or video fusion is performed on the video data locally. The other requirement may be that the target data to be outputted must match a target application, such that the target application can at least directly output the target data to be outputted.

When the two basic requirements are met, the first audio data and/or the first image data may be processed to in one or more ways. For example, multiple channels of first audio data obtained from a microphone matrix may be synthesized into one channel of audio data. In this way, compared with the simultaneous upload of multiple channels of video to the target application and its cloud, the data size of the audio data can be significantly reduced. In another example, for the purpose of improving audio clarity, noise reduction processing may also be performed on the first audio data. Alternatively, for the purpose of forming a specific audio effect, stereo processing may also be performed on the first audio data, such that the target data to be outputted can have a spatial sound effect. In another example, in order to match the target application such that the target application can directly output the target audio data, format conversion may also be performed on the first audio data based on the configuration parameters of the target application to form the target audio data, thereby meeting the output standard of the target application.

In some embodiments, the effective image data in remote video conferencing mainly includes the participants images as well as specific display data that need to be viewed by the participants, such as PPT images, whiteboard images, product images, etc. The original image obtained by the image collection device may be cropped to obtain the effectively images such as participants images, PPT images, whiteboard images, product images, etc. to form the target image data and reduce communication bandwidth requirements. In addition, the resolution, definition, size, and encoding method of the image data may also be modified to reduce the data size of the target image data.

In some embodiments, in order to meet the output mode requirements of the target application, the first image data may be processed based on the configuration parameters of the target application to form the target image data to meet the output standard of the target application. For example, based on the size and format of the GUI of the target application, cropping and conversion may be performed on the participants images and other target images in the first image data.

130, outputting the target data to be outputted to the target application running on a second electronic device having a communication connection with the first electronic device for the target application to at least directly output the target data to be outputted.

In some embodiments, if the target data to be outputted is obtained, the target data to be outputted may be output to one or more secondo electronic devices based on the communication connection between the first electronic device and the second electronic device.

For example, in the case where the second electronic device is a conference machine, multiple participants may use the conference machine set in the meeting room to participate in the meeting at the same time. At this time, it is only necessary to output the target data to be outputted to the conference machine, and output the target data to be outputted through the target application running on the conference machine to meet the video conferencing needs of multiple conference participants.

In another example, in the case where there are multiple conference participants, and multiple conference participants use their own second electronic devices to participate in the conference, the target data to be outputted may be sent to each second electronic device respectively, and the target data to be outputted may be output through the target application running on each second electronic devices.

In the case of multiple second electronic devices, the target applications running by the multiple second electronic devices may be the same application program, or the target applications run by the multiple second electronic devices may also be different application programs.

In the case that the target applications run by multiple second electronic devices are different application programs, the first electronic device only needs to output the target data to be outputted that meets the requirements of each application program based on the configuration parameters of each application program, such that each application program can directly output their respective target data to be outputted.

In another example, in the case that the second electronic device can support multiple application programs to output audio data and/or image data respectively, the target data to be outputted may also be respectively output to each target application of the second electronic device, and the target data to be outputted may be respectively output through each target application. Take the second electronic device is a server as an example, multiple virtual machines may run on the second electronic device, and each virtual machine may be provided to different users. The first electronic device may respectively output the target data to be outputted to the target applications running on each virtual machine, and output the respective target data to be outputted through the target applications running on each virtual machine.

In some embodiments, in order to enhance the conference experience and improve the sound effect and/or image display effect, after the second electronic device obtains the target data to be outputted, the second electronic device may further process the target data to be outputted. For example, special effects may be applied to audio or image data. The further processing may be completed by the second electronic device itself, or by the server.

In the processing method provided by the embodiments of the present disclosure, the first audio data and/or the first image data may be obtained, and at least one process may be performed on the first audio data and/or the first image data to obtain the target data to be outputted. The data size or the entire data may be compressed, such s video fusion, to form the target data to be outputted that matches the target application running on the second electronic device. The second electronic device may be configured to obtain the target data to be outputted, and directly output the target data to be outputted through the target application without the cloud or the server for auxiliary data processing which can reduce the dependence on the data processing capability of the cloud or the server, thereby improving the meeting fluency.

In some embodiments, the first audio data and/or the first image data may be obtained in various ways. The specific processes for obtaining the first audio data and/or the first image data are exemplified below in conjunction with several specific embodiments, but it should not be understood that the methods of obtaining the first audio data and/or the first image data are not limited thereto.

In some embodiments, the process at 110, obtaining the first audio data and/or the first image data may include using the microphone array and/or camera array of the first electronic device to obtain audio data and/or image data in a target space environment as the first audio data and/or the first image data.

In some embodiments, the target space environment may be the space environment where the first electronic device is located, and the microphone array and/or camera array may adjust their acquisition range in the target space environment based on change information in the target space environment.

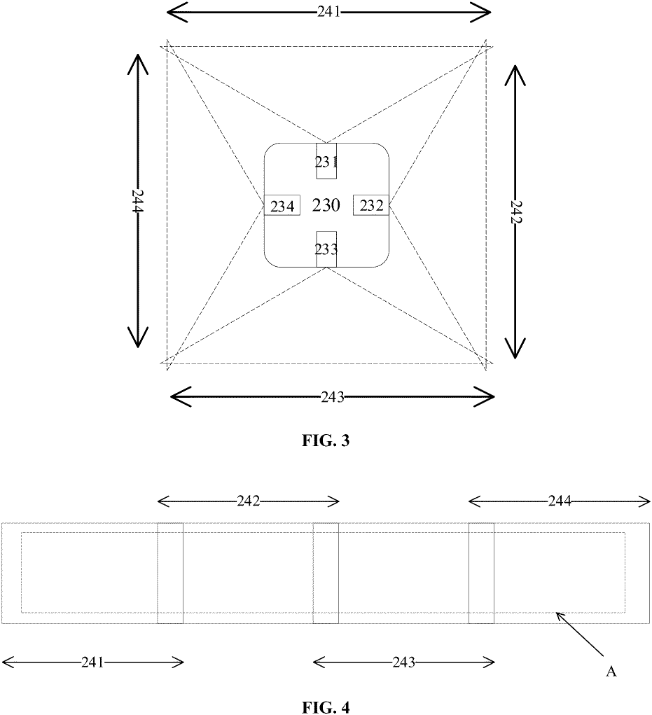

In some embodiments, as shown in FIG. 2, a first electronic device 200 can be a conference machine, and the conference machine can include a base 210, a body 220, a microphone array (not shown in FIG. 2), and a camera array 230. The body 220 may be arranged on top of the base 210, and components such as processors and memories may be arranged in the baes 210. The microphone array may include a plurality of microphones arranged in an array on the body 220. The camara array 230 may include a plurality of cameras 231, 232, 233, and 234. The plurality of cameras 231, 232, 233, and 234 may be arranged sequentially along the circumferential direction of the body 220, and the plurality of cameras 231, 232, 233, and 234 may have different imaging ranges respectively. The imaging ranges of the plurality of cameras 231, 232, 233, and 234 may form a circular imaging range, such as shown in FIG. 3 and FIG. 4. The audio data in the target space environment may be obtained through the microphone array on the first electronic device 200, and the image data of the circular imaging range centered on the first electronic device 200 or the panoramic image data of the space environment in which the camera array 230 is located may be obtained through the camera array 230.

In some embodiments, the change information of the target space environment may include sound source position change information, sound source quantity change information, sound source energy change information, etc. Further, the change information of the target space environment may also include image object position change information and image object quantity change information. During the process of obtaining the first audio data and/or the first image data, based on the change information, the collection range of the microphone array in the target space environment may be adjusted, or the collection range of the camera array in the target space environment may be adjusted. In other embodiments, it is also possible to adjust the control parameters of the microphone array by using the position change information of an object or the object quantity change information in the target space environment collected by the camera array. Alternatively, the control parameters of the microphone array and/or the camera array may also be adjusted after detecting the change information through other sensors, such as the HPD sensor.

In some embodiments, adjusting the collection range may be achieved by adjusting the microphone array, microphones, camera array, or cameras. For example, the sensitivity or the pickup mode of the microphones may be adjusted, or the focal length or the focus point of the cameras may be adjusted.

In some embodiments, adjusting the collection range may also be achieved by adjusting the conference machine. For example, the body may be configured to be rotatably connected to the base, and the sound source location change information, sound source quantity change information, and/or the sound source energy change information may be obtained based on the audio data. Based on the sound source position change information, the sound source quantity change information and/or the sound source energy change information, the body may be controlled to rotate to adjust the collection angles of the microphone array and the camera array. For example, one camera may be adjusted face the sound source, or the microphone array may be adjusted to obtain the best collection effect. In another example, the corresponding position change information of the image and the image object quantity change information may be identified based on the image data. Based on the image object position change information and/or the image object quantity change information, the body may be controlled to rotate to adjust the collection angles of the microphone array and the camera array, thereby adjusting the collection range of the microphone array and the camera array. In addition, the body may be configured to be mounted on the base in a liftable manner, or the bottom of the base may also be provided with a moving mechanism. Based on the change information, the body may be controlled to move up and down, or the walking mechanism may be controlled to move, thereby driving the conference machine to change the collection position to adjust the collection range.

In some embodiments, the process at 110, obtaining the first audio data and/or the first image data may include using the audio data and/or the image data from the target application as the first audio data and/or the first image data.

That is, the first audio data and the first image data are not limited to being obtained by the first electronic device itself, and the first audio data and the first image data may also be obtained by one or more target applications of the second electronic device. Take the first electronic device as a conference machine, and one or more second electronic devices as mobile terminals used by meeting participants as an example. After each mobile terminal obtains the first audio data and/or the first image data through its audio collection device and image collection device, the first audio data and/or the first image data may be sent to the conference machine through the target application, and the conference machine may process the first audio data and the first image data into the target data to be outputted. Subsequently, the target data to be outputted may be respectively fed back to each mobile terminal, and the target data to be outputted may be output through the target application program on the mobile terminal.

In some embodiments, the target application may include one application, or multiple applications of the same and/or different types. For example, the conference machine may only communicate with a second electronic device, and only one target space environment may run on the second electronic device, such Microsoft Teams, Tencent meeting, QQ, WeChat, Skype, or other video software. In another example, the first electronic device may also be communicatively connected to a second electronic device, and multiple target applications may run on the second electronic device. The multiple target applications may be the same application program, or the multiple target applications may be different application programs. In another example, the first electronic device may also be communicatively connected to multiple second electronic devices, the target applications running on the multiple second electronic devices may be the same application programs, and the target applications running on the multiple second electronic devices may also be different application programs.

In some embodiments, the process at 110, obtaining the first audio data and/or the first image data may include using the audio data and/or the image data in the target space environment collected by the microphone array and/or the camera array of the first electronic device, and the audio data and/or the image data from the target application as the first audio data and/or the first image data.

In some embodiments, the target space environment may be the space environment where the first electronic device is located, and the microphone array and/or camera array may adjust their acquisition range in the target space environment based on change information in the target space environment. The target application may include one application, or multiple applications of the same and/or different types.

That is, the obtained first audio data and/or first image data may include the audio data and/or the image data collected by the first electronic device in the target space environment, and may also include audio data and/or image data from a target application running on the second electronic device. For example, still take the first electronic device as a conference machine as an example. The conference machine may be placed in the conference room, and those who cannot attend the conference may communicate with the conference machine through their mobile terminals. The conference machine can not only collect the audio data and/or image data in the conference room through its microphone array and/or camera array, but also obtain the audio data and/or image data of the remote participants collected by each mobile terminal.

In some embodiments, the process at 110, obtaining the first audio data and/or the first image data may include using the audio data and/or the image data in the target space environment collected by the microphone array and/or the camera array of the first electronic device, the audio data and/or the image data from the target application, and the audio data and/or the image data collected from a third electronic device as the first audio data and/or the first image data.

In some embodiments, the target space environment may be the space environment where the first electronic device is located, and the microphone array and/or camera array may adjust their acquisition range in the target space environment based on change information in the target space environment. The target application may include one application, or multiple applications of the same and/or different types.

Still take the first electronic device as a conference machine, and the second electronic device as the mobile terminals used by remote participants as an example. The conference machine may be arranged in the conference room, and the mobile terminals may communicate with the conference machine. When the conference topic involves participants in other spaces other than the conference room and space where the remote participants are located, audio data and/or image data of the other spaces may be collected through the third electronic device. The conference machine may process the audio data and/or image data obtained from the first electronic device, the audio data and/or image data obtained by the second electronic device, and the audio data and/or image data obtained by the third electronic device together as the target data to be outputted.

In some embodiments, the first audio data and/or the first image data may be processed by various processing methods to obtain the target data to be outputted. The processing methods are illustrated below in conjunction with several specific embodiments, but it should not be understood that the processing methods are not limited thereto.

In some embodiments, the process at 120, performing at least one process on the first audio data to obtain target data to be outputted may include performing at least one process on the first audio data based on the change information in the target space environment to obtain the target data to be outputted.

In some embodiments, the at least one process may include noise reduction processing, sound effect processing, data stream merging, data format conversion, or other types of data generated based on the audio data, such as image data or video data generated based on the audio data.

In some embodiments, in the case where a microphone array is used to collect multiple channels of first audio data, one of the first audio data with better audio effect may be selected for noise reduction processing. After the noise reduction process, the first audio data may be used as the target audio data. Alternatively, noise reduction processing may also be performed on multiple channels of first audio data separately, and then the multiple channels of first audio data may be combined after noise reduction processing into one channel of target audio data. In the case where the format of the target audio data does not match the target application, in order for the target application to directly output the target audio data, format conversion may also be performed on the target audio data.

In some embodiments, the spatial type change information of the target space environment may also be determined based on the first image data, such as determining the three-dimensional spatial structure of the target space environment. Based on the three-dimensional spatial structure, the first audio data may be processed to generate the first audio data with spatial sound effects.

In some embodiments, the first audio data may also be processed based on change information in the target space environment to obtain other types of target data. For example, the target sound source may be identified based on the position and volume of the sound source in the first audio data, and the voice data of the target sound source may be obtained from the first audio data. Voice recognition may be performed on the voice data to obtain the corresponding text data, and the voice data and the text data may be used as the target data to be outputted The target application may output the voice data, and out, for example, subtitles based on the text data.

In another example, when the target sound source is determined, based on the voice data of the target sound source, the sound-to-image processing may be performed to generate the target image data. The voice data and the target image data may be used as the target data to be outputted. The target application may output the voice data. If there is no whiteboard in the meeting, a whiteboard may be simulated based on the target image data to improve the efficiency of the video conference. In some cases, video data may also be generated based on the first audio data. For example, a video animation may be simulated based on the first audio data, such that the video conference can be more vivid.

In some embodiments, the process at 120, performing at least one process on the first audio data to obtain the target data to be outputted may include, in response to obtaining instruction information generated by operations acting on the target application, performing at least one process on the first audio data to obtain the target data to be outputted.

In some embodiments, participants (that is, users) may operate on the target application to generate instruction information based on their preferences or needs. The instruction information may be used to instruct the first electronic device to perform at least one process on the first audio data, thereby obtaining the target data to be outputted that meets the needs of the participants.

For example, participants may choose whether to perform voice recognition or whether to display subtitles based on their needs. When the participants choose to perform voice recognition or display subtitles, corresponding instruction information can be generated. The first electronic device may perform voice recognition on the first audio data based on the instruction information, obtain text data, and send the first audio data and the text data as the target data to be outputted to the second electronic device. In this way, the target application can obtain the recorded text data, or the target application can control the display unit of the second electronic device to display subtitles.

In another example, each participant may choose the sound effect type based on their preferences or needs, such as surround sound, stereo sound, etc. The target application may generate the corresponding instruction information based on the user’s selection operation. Based on the instruction information, the first electronic device may process the first audio data to form the target audio data with the corresponding sound effects, and take the target audio data as the target data to be outputted.

In some embodiments, the process at 120, performing at least one process on the first audio data to obtain the target data to be outputted may include performing at least one process on the first audio data based on target space environment information and resource information of the first electronic device to obtain the target data to be outputted.

The target space environment information may represent the application scene of the target space environment, such as information used to identify the target space environment as a meeting scene, a live broadcast scene, or a classroom scene, etc. The resource information may be used to characterize the usage of the first electronic device, such as the usage rate or the usage rate of the physical content of the process of the first electronic device. In this way, the first electronic device can intelligently select a processing operation for the first audio data based on the target space environment information and its current processing capability, thereby improving the audio effect and the smoothness of the conference.

For example, when the first electronic device has sufficient processing capability, the first electronic device may select one or more processing operations with a large amount of data processing to form a better audio effect. For example, operations such as sound source localization, echo cancellation, noise reduction, and gain processing may be performed on the first audio data.

When the processing capability of the first electronic device itself is tight, a processing operation with a small amount of data processing may be selected to prevent the first electronic device from being stuck and ensuring smoothness of the conference. For example, when the processor usage rate of the first electronic device is high, only one channel of first audio data with better audio quality may be selected from multiple channels of first audio data, and process such as noise reductio, echo cancellation, or gain processing may not be performed on the first audio data.

In some embodiments, the process at 120, performing at least one process on the first image data to obtain the target data to be outputted may include performing at least one process on the first image data based on the change information in the target space environment to obtain the target data to be outputted.

In some embodiments, position change information, quantity change information, type change information, etc. of the target object within the target space environment may be determined based on the first audio data and/or the first image data. For example, the change information of the target object such as people, whiteboards, and products may be identified based on the first image data. Subsequently, based on the change information of the target object, the images of each target object may be respectively captured from the first image data, and multiple video streams respectively corresponding to each target object may be formed as the target data to be outputted. In addition, the target application may display each target object through multiple windows based on the multiple video streams.

In some embodiments, the process at 120, performing at least one process on the first image data to obtain the target data to be outputted may include, in response to obtaining the instruction information generated by operations acting on the target application, performing at least one process on the first image data to obtain the target data to be outputted.

In some embodiments, conference participants may also operation the target application based on their needs to generate the instruction information. The instruction information may be used to instruct the first electronic device to process the first image data, thereby obtaining the target data to be outputted that meets the needs of each participant. In some embodiments, conference participants may choose the image display method, for example, the participants may choose to display each target object separately, or display the image of the conference room as a whole. When the participants choose to display each target object separately, the first electronic device may identify the people, whiteboard, product, display panel, etc. in the first image data, and generate multiple video streams respectively. After obtaining the multiple video streams, the target application may display multiple target objects based on the multiple video streams. When the conference participants choose to display the image of the conference room as a whole, the image data collected by multiple cameras arranged in a ring along the circumference of the body may be obtained. Based on the multiple image data spliced into the overall image data of the circular imaging range, the target application may display the image of the conference room as a whole based on the overall image data.

In some embodiments, the process at 120, performing at least one process on the first image data to obtain the target data to be outputted may include performing at least one process on the first image data based on the target space environment information and the resource information of the first electronic device to obtain the target data to be outputted.

In some embodiments, usage modes corresponding to various usage scenarios and the configuration parameters of the target output data corresponding to each usage mode may be set in advance. The first electronic device may be configured to identify the target space environment information based on the first image data, determine the usage scenario of the target space environment based on the target space environment information, determine the usage mode based on the usage scenario, and determine the configuration parameters of the target data to be outputted. That is, the target effect of the target data to be outputted can be determined.

In some embodiments, a whiteboard mode, a speech mode, a comparison mode, a display mode, etc. may be set in advance.

The whiteboard mode may be configured for use by one or more presenters using a whiteboard or a display device to present content. In this usage mode, the target application needs to output a whiteboard image with a relatively large size and a relatively high definition, and output the images of conference participants with a relatively small size and a relatively low definition, such as shown in part f in FIG. 6.

The speech mode may be for presenters to speak without the help of a whiteboard and a display device. In this usage mode, the target application needs to output the image of the speaker with a relatively large size and a relatively high definition, and output the images of other conference participants with a relatively small size and a relatively low definition, such as shown in part d in FIG. 6.

The comparison mode may be suitable for product comparison or operation process comparison. In this usage mode, the target application needs to output more than two product images or more than two operation process images for comparison, such as shown in part a in FIG. 6.

The display mode is suitable for product display, and the target application needs to output the image of the displayed product or other object to be displayed, such as shown in part e in FIG. 6.

When the configuration parameters of the target data to be outputted are determined, the hardware resources and software resources currently available to the first electronic device may be determined based on the resource information of the first electronic device. In addition, the resource information may include the idle rate of the CPU, the idle rate of the GPU, the idle rate of the NPU, and the idle rate of the physical memory of the first electronic device. At least one process operation may for the first image data may be determined based on the currently available hardware resources and software resources of the first electronic device, and the configuration parameters of the target data to be outputted, thereby improving the smoothness of data processing, avoiding data congestion, and ensuring the smoothness of the meeting on the basis of obtaining the target data to be outputted.

In some embodiments, the process at 120, performing at least one process on the first image data to obtain the target data to be outputted may include performing at least one process on the first image data based on configuration information and/or usage information of an output component for outputting the target data to be outputted to obtain the target data to be outputted.

In some embodiments, the output component may be a display unit of the second electronic device, or a display unit connected to the second electronic device. The configuration information of the output component may include information such as size, resolution, refresh rate, and color of the display unit. The usage information of the output component may include the display mode of the display unit or display device, the resolution selected by the user, scene information of the scene, etc.

Each second electronic device may send the configuration information and/or usage information of the respective output components to the first electronic device based on its respective communication path with the first electronic device. The first electronic device may process the first image data based on the configuration information and/or the usage information of the output components to generate the target data to be outputted that matches each output component. In some embodiments, the at least one process may include image editing (such as cropping), image enhancement, image fusion, binarization, blurring, privacy processing, image coding, image compression, image special effect processing, etc. In this way, the formatted target data to be outputted can match the configuration information and/or the usage information of the output component, and the output component can output display content based on the target data to be outputted, thereby improving the display effect.

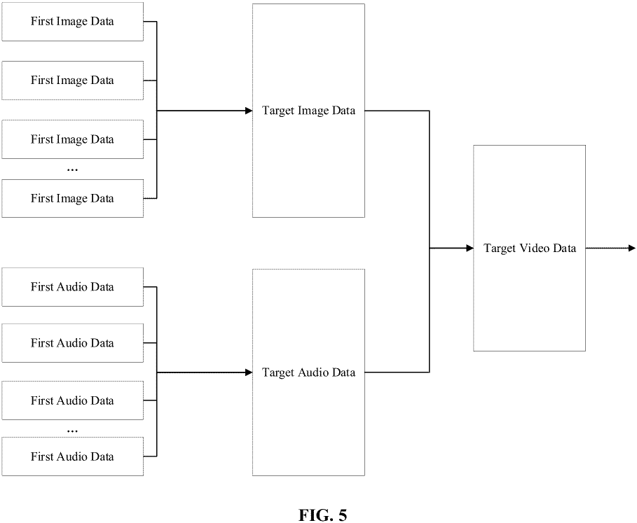

Referring to FIG. 5. In some embodiments, the process at 120, performing at least one process on the first audio data and the first image data to obtain the target data to be outputted may include processing a plurality of first audio data obtained based on a control signal into the target audio data, processing a plurality of first image data obtained based on the control signal into the target image data, merging the target audio data and the target image data based on the control signal to obtain the target data to be outputted, where the control signal may at least include a signal for triggering a microphone array or a camera array of the first electronic device to collect corresponding data. The control signal may be used to control the acquisition timing, source, and collaboration acquisition of audio data and image data, etc.

In some embodiments, the first electronic device may obtain a plurality of first audio data based on the control signal. For example, the first electronic device may obtain the first audio data collected by the microphone array based on the control signal, obtain the first audio data sent by the target application of the second electronic device, and the first audio data collected by the third electronic device, etc. After obtaining the plurality of first audio data, the first electronic device may fuse the plurality of first audio data into target audio data based on the control signal.

In the case where a microphone array is arranged on the first electronic device, the first electronic device may also include an audio signal processing chip. The plurality of microphones in the microphone array may generate a plurality of first audio data, and the audio signal processing chip may fuse the plurality of first audio data into the target audio data based on the control signal.

In some embodiments, the first electronic device may obtain a plurality of first image data based on the control signal. For example, a camera array may be arranged on the first electronic device, or the first electronic device may respectively obtain the first image data collected by its camera, the first image data sent by the target application of the second electronic device, and the first image data collected by the third electronic device. After obtain the plurality of first image data, the first electronic device may fuse the plurality of first image data into target image data based on the control signal.

In some embodiments, multiple cameras may be arranged along the circumference of the body of the first electronic device, and the imaging ranges of the multiple cameras may form a ring-shaped imaging range. The first electronic device may also include a graphic signal processing chip, and the plurality of cameras may respectively collect the first image data of their respective imaging range. The graphic signal processing chip may fuse multiple pieces of first image data into the target image data based on the control signal, such as shown in part A of FIG. 4.

When the target audio data and the target image data are obtained, the first electronic device may fuse the target image data and the target audio data into target video data based on time information. Both the target audio data and the target image data may contain time information as stream data, and the two may be synthesized based on the time information, such as video data in HDMI format, DP format, or other formats that may be generated. In this way, the output operation of the target application on the target data to be outputted can be simplified, thereby improving the smoothness of the meeting.

Referring to FIG. 6. In some embodiments, the process at 120, performing at least one process on the first audio data and the first image data to obtain the target data to be outputted may include determining the current use mode of the first electronic device, selecting the target audio data and the target image data from the first audio data and the first image data based at least one the use mode, and performing fusion processing on the target audio data and the target image data based at least one the use mode to obtain the target data to be outputted, where the target data to be outputted may also be determined by the display output parameters in the use mode.

In some embodiments, a plurality of use modes, such as the whiteboard mode, the speech mode, the comparison mode, and the display mode, may be set in advance in the first electronic device. Various use modes may be applied to different usage scenarios. For example, the whiteboard mode may be suitable for one or more presenters who are presenting on a whiteboard or a projector, the speech mode may be suitable for the speaker to speak without the help of the whiteboard or display, the comparison mode may be suitable for comparing two or more products or two or more operation processes, and the display mode may be suitable for the usage scenarios of product display.

The current use mode of the first electronic device may be determined based on the user’s selection. Or, the current usage scenario of the first electronic device may be determined based on image recognition of the first image data collected by the first electronic device, and the use mode may be determined based on the determined usage scenario.

After the current use mode of the first electronic device is determined, the target audio data and the target image data may be selected from the first audio data and the first image data based on the use mode. For example, in the whiteboard mode, the voice data of the presenter may be extracted from the first audio data, noise reduction may be performed on other irrelevant audio data, and the whiteboard image, the image of the presenter, and images of the participants, etc. may be captured from the first image data. In the speech mode, the voice data of the speaker may be extracted from the first audio data, noise reduction may be performed on other irrelevant audio data, and the images of the speaker and the participants may be captured from the first image data. In the comparison mode, images of the two or more products being compared may be captured from the first image data, or comparison images of the two or more operation processes being compared may be captured, and the audio data related to the compared produces or operation process may be extracted from the first audio data. In the display mode, the image of the demonstrated product may be captured from the first image data, the audio data of the person introducing the product may be extracted from the first audio data, and noise reduction may be performed on other irrelevant audio data.

In some embodiments, when the target audio data and the target image data are obtained, the target audio data and the target image data may be fused based on the use mode and the display output parameters in the use mode to obtain the target data to be outputted. The display output parameters may include configuration parameters and usage parameters of the display output component of the first electronic device, such as the size and resolution of the display screen of the target data to be outputted. The display output parameters may also include configuration parameters and usage parameters of the output terminal, that is, the configuration parameters and usage parameters of the output component of the second electronic device, such as the configuration parameters and the usage parameters of the display output component and the audio output component of the second electronic device. In this way, the target data to be outputted can not only adapt to the use mode, but also adapt to the display output component of the first electronic device itself and the output component of the second electronic device.

For example, on the basis of satisfying the configuration parameters and usage parameters of each display output component, in the whiteboard mode, the whiteboard image may retain a relatively high definition and a relatively large size, and the images of other participants may retain a relatively low definition and a relatively small size, such as shown in part f in FIG. 6. In the speech mode, the image of the speaker may retain a relatively high definition and a relatively large size, and the images of other participants may retain a relatively low definition and a relatively small size, such as shown in part d in FIG. 6.

It should be noted that FIG. 6 is drawn based on collected images, and is only used to exemplarily display image elements such as images of people, whiteboard images, product images, and PPT images, and to exemplify how the output terminal displays different image elements based on the target data to be outputted in different use modes. The specific text content in the whiteboard image and PPT images is not relevant to the present disclosure, therefore it is not necessary to clearly display the text content.

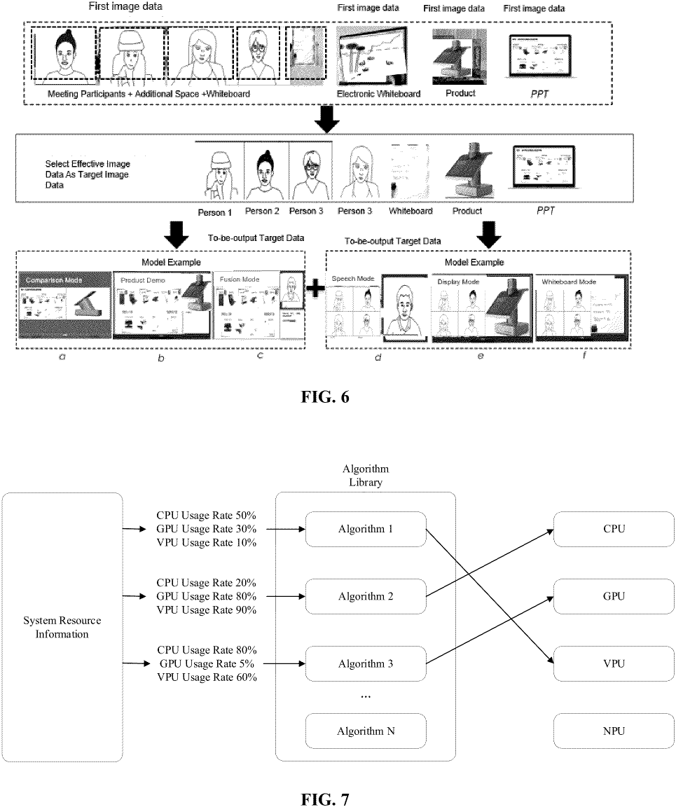

Referring to FIG. 7. In some embodiments, the process at 120, performing at least one process on the first audio data and/or the first image data to obtain target data to be outputted may include obtaining system resource information of the first electronic device, determining a target algorithm set from an algorithm library preset by the first electronic device based on the system resource information, and using an algorithm model in the target algorithm set to perform the corresponding processing on the first audio data and/or the first image data to obtain the target data to be outputted.

In some embodiments, the algorithm library may be located in the first electronic device or in the space environment where the first electronic device is located, such as in other peripheral devices connected to the first electronic device. Alternatively, the algorithm library may also be located on the cloud. The algorithm library may include a plurality of algorithm models, such as algorithm models for processing audio data, algorithm models for processing image data, algorithm models for processing video streams, etc.

In some embodiments, the system resource information may include hardware resource information and software resource information of the first electronic device. The hardware resource information may include, but is not limited to, CPU usage rate, physical memory usage rate, GPU usage rate, NPU usage rate, temperature of each component, etc. The software resource information may include the system usage rate, number of processes, number of tasks, etc.

When the system resource information of the first electronic device is obtained, the hardware resources and the software resources available to the first electronic device may be determined based on the system resource information of the first electronic device, and the algorithm model matching the available hardware resources and software resources may be determined from the preset algorithm library to generate a target algorithm set. For example, on the basis of achieving the same target processing effect of the data to be outputted, if the CPU usage rate is relatively low, algorithm 2 may be selected from the preset algorithm library to be executed by the CPU, and if the GPU usage rate is relatively low, algorithms 3 may be selected from the preset algorithm library to be executed by the GPU, such as shown in FIG. 7.

In some embodiments, the target algorithm set may be correspondingly updated based on changes in the system resource information. That is, during the process of processing the first audio data and/or the first image data, the use of hardware resources and software resources of the first electronic device is constantly changing, and the system resource information of the first electronic device changes accordingly. Therefore, the algorithm models in the target algorithm set may be dynamically adjusted as the system resource information changes. For example, as the CPU usage gradually increase, at least part of the algorithm models to be executed by the CPU may be removed from the target algorithm set. On the basis of achieving the same or substantially the same processing effect, the algorithm to be executed by the GPU may be added to the target algorithm set to avoid congestion of hardware resources and software resources and ensure the smoothness of data processing.

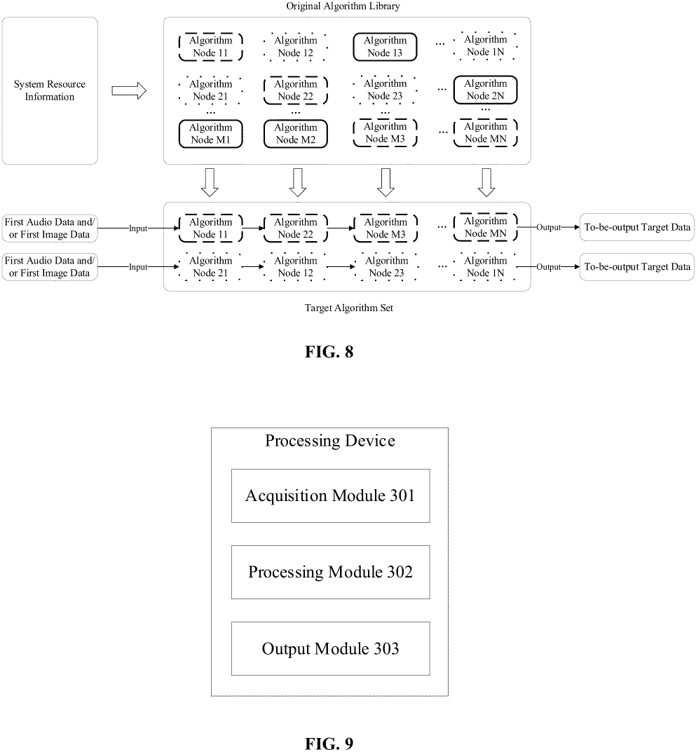

Referring to FIG. 8. In some embodiments, the process at 120, performing at least one process on the first audio data and/or the first image data to obtain target data to be outputted may include obtaining the system resource information of the first electronic device, optimizing the original algorithm model based on the system resource information, and using the optimized target algorithm model or target algorithm set to perform corresponding processing on the first audio data and/or the first image data to obtain the target data to be outputted.

In some embodiments, an algorithm library may be preset in the first electronic device or in the space environment where the first electronic device is located. A plurality of original algorithm models may be preset in the algorithm library, and the original algorithm models may include a plurality of algorithm nodes or algorithm units, such as shown in FIG. 8.

In some embodiments, the system resource information of the first electronic device may be obtained. The system resource information may include hardware resource information and software resource information of the first electronic device. The hardware resource information may include, but is not limited to, CPU usage rate, physical memory usage rate, GPU usage rate, NPU usage rate, temperature of each component, etc. The software resource information may include the system usage rate, number of processes, number of tasks, etc.

When the system resource information of the first electronic device is obtained, the hardware resources and the software resources available to the first electronic device may be determined based on the system resource information of the first electronic device. Based on the available hardware resources and software resources of the first electronic device, the original algorithm models may be pruned, quantized, or compressed to form a target algorithm model that matches the currently available hardware resources and software resources of the first electronic device. The target algorithm set may be formed by the optimized target algorithm model, and the first audio data and/or the first image data may be processed based on the target algorithm model in the target algorithm set to obtain the target data to be outputted, such as shown in FIG. 8. For example, if the current CPU usage rate of the first electronic device is relatively low, the original algorithm model may be optimized to form a target algorithm model to be executed mainly by the CPU.

In some embodiments, the target algorithm set or the target algorithm model may be updated correspondingly based on changes in the system resource information. That is, as the availability of hardware resources and software resources of the first electronic device changes continuously, the target algorithm set or the target algorithm model may be dynamically adjusted. For example, as the CPU usage rate gradually increase, the algorithm nodes or algorithm units in the target algorithm model that are mainly executed by the GPU may be removed and replaced by the algorithm nodes executed by the CPU or other processors. In this way, the target algorithm set and the target algorithm model can be dynamically adjusted based on the real-time changes of the hardware resources and software resources of the first electronic device, thereby ensuring the smoothness of data processing.

In some embodiments, the process at 130, outputting the target data to be outputted to the target application running on the second electronic device having a communication connection with the first electronic device may include, if the first audio data and/or the first image data includes audio data and/or image data from a first target application, outputting the target data to be outputted to a second target application different from the first target application, the first target application and the second target application being run on different second electronic devices.

In some embodiments, after the audio data stream and the video data stream area processed by the first electronic device, the target data to be outputted that match different types of first target application and second target application may be formed respectively, and the respective target data to be outputted may be sent to the first target application and the second target application respectively. In this way, the video streams of different conference terminals may be shared between different conference terminals and different application programs after being processed by the first electronic device, which no longer restrict the participants to use the same application program, thereby reducing the difficult of video conferencing.

In some embodiments, the process at 130, outputting the target data to be outputted to the target application running on the second electronic device having a communication connection with the first electronic device may include, if the first audio data and/or the first image data includes audio data and/or image data from a first target application, outputting the target data to be outputted to a third target application that is identical to the first target application, the first target application and the third target application being run on different second electronic devices.

After the first audio data and/or the first image data are processed into the target data to be outputted by the first electronic device, it may be shared between the same type of first target application and third target application of different participants to meet the needs of remote video conferencing with multiple people.

In some embodiments, the process at 130, outputting the target data to be outputted to the target application running on the second electronic device having a communication connection with the first electronic device may include, in response to obtaining a sharing request from the first target application, the sharing request including a sharing object of the target data to be outputted, outputting the target data to be outputted to a fourth target application corresponding to the sharing object, the fourth target application and the first target application being the same or different applications running on different second electronic devices.

In some embodiments, the first target application may be an application program running on a terminal device used by a conference administrator, and the conference administrator may send a sharing request to the first electronic device based on the conference terminal information of different participants. That is, the sharing object may include conference terminal information of different participants. The conference terminal information may include device information of the terminal device used by the participants, the application information of the target application running on the terminal device, the personal identity information of the participants registered in the target application, etc.

After receiving the sharing request, the first electronic device may share the target data to be outputted to the same target application running on different second electronic devices or different target applications based on the information of the conference terminal. In this way, different participants can use the same or different target applications to participate in the video conference, which greatly improves the flexibility of the video conference.

In some embodiments, the method may further include outputting the target data to be outputted to a target output component. The target output component may include an output component of the first electronic device and/or a display output component and/or an audio output component connected to the first electronic device. In some embodiments, the target data to be outputted may be output to the target output component and the target application through the same or different channel.

That is, in some embodiments, the target data to be outputted may not be limited to output to the target application running on the second electronic device, but may also be output to the output component of the first electronic device, or an output component connected to the first electronic device. The target output component may include an output component of the first electronic device, and/or a display output component and/or an audio data component connected to the first electronic device. That is, the target output component may be used as a component of the first electronic device, such as a display component, an audio playback component, etc. of the first electronic device. The target output component may also be an external device connected to the first electronic device, such as a display screen connected to the first electronic device, or an audio output device, such as a speaker, connected to the first electronic device.

In fact, the target output component may include any type of output device, such as display devices, audio playback devices, lighting devices, printing devices, etc. For example, when the target data to be outputted includes text data, a paper-based meeting minutes may be printed through a printing device. Alternatively, if the target data deice includes instruction information for instructing the content of the meeting or the progress of the meeting, the instruction information may be sent to the lighting device, and the lighting effect of the lighting device may be controlled through the instruction information as a reminder for the meeting process or the meeting progress, thereby enriching the meeting form.

When outputting the target data to be outputted to the target output component and the target application, the same data channel or different data channels may be used. For example, the target data to be outputted may be sent to the target application running on the second electronic device through a wired network or a wireless network. When the target data component is an output component of the first electronic device itself, the target data to be outputted may be directly sent to the target output component through an internal data channel. In another example, when the target output component is an output device connected to the first electronic device, the first electronic device may also send the target data to be outputted to the target output component and the target application respectively through a wired network, or respectively send the target data to be outputted to the target output component and the target application through a wireless network. In another example, the first electronic device may also select a data channel based on the data type and data size of the target data to be outputted.

Referring to FIG. 2. An embodiment of the present disclosure also provides an electronic device. That is, the first electronic device shown in FIG. 2. The electronic device may include a body, a microphone array, a camera array 230, a processing device, and a memory. The microphone array may include multiple microphones, which may be arranged on the body, and the microphones may be used to collect audio data in the environment where the first electronic device is located. The camera array 230 may include a plurality of cameras 231, 232, 233, and 234, and the plurality of cameras 231, 232, 233, and 234 may be arranged in an array on the body. The plurality of cameras 231, 232, 233, and 234 may be configured to have their own imaging range for collecting image data in their respective imaging ranges. The processing device and the memory may be arranged in the body. The memory may store a program. When the program stored in the memory is executed by the processing device, the processing device may realize the processing method described in any one of the foregoing embodiments.

In some embodiments, the body may include a base 210 and a body 220. The body 220 may be disposed on top of the base 210, the processing device, the memory, and other components may be disposed in the base, and the microphone array may be arranged on the body. The plurality of cameras 231, 232, 233, and 234 may be arranged sequentially along the circumferential direction of the body 220, and the plurality of cameras 231, 232, 233, and 234 may have different imaging ranges respectively. The imaging ranges of the plurality of cameras 231, 232, 233, and 234 may form a circular imaging range, such as shown in FIG. 3 and FIG. 4.

As shown FIG. 9, an embodiment of the present disclosure further provides a processing device. The processing device may include an acquisition module 301, a processing module 302, and an output module 303. The acquisition module 301 may be configured to obtain the first audio data and/or the first image data. The processing module 302 may be configured to perform at least one process on the first audio data and/or the first image data to obtain the target data to be outputted. The output module 303 may be configured to output the target data to be outputted to a target application running on a second electronic device having a communication connection with the processing device for the target application to at least directly output the target data to be outputted. In some embodiments, the data size of the target data to be outputted may be different from the data size of the first audio data and/or the first image data.

In some embodiments, the acquisition module 301 may be further configured to use the microphone array and/or camera array of the processing device to collect audio data and/or image data in the target space environment as the first audio data and/or the first image data; or, use the audio data and/or image data from the target application as the first audio data and/or the first image data; or, use the audio data and/or image data in the target space environment collected by the microphone array and/or camera array of the processing, and the audio data and/or image data from the target application as the first audio data and/or the first image data; or, use the audio data and/or image data in the target space environment collected by the microphone array and/or camera array of the processing, the audio data and/or image data from the target application, and the audio data and/or image data collected from a third electronic device as the first audio data and/or the first image data.

In some embodiments, the target space environment may be a space environment where the processing device is located, and the microphone array and/or the camera array may adjust their collection range in the target space environment based on change information in the target space environment. In addition, the target application may include one application, or multiple applications of the same and/or different types.

In some embodiments, the processing module 302 may be configured to perform at least one process on the first audio data based on the change information in the target space environment to obtain the target data to be outputted; or, in response to obtaining instruction information generated by operations acting on the target application, perform at least one process on the first audio data to obtain the target data to be outputted; or, perform at least one process on the first audio data based on the target space environment information and the resource information of the processing device to obtain the target data to be outputted.

In some embodiments, the processing module 302 may be configured to perform at least one process on the first image data based on the change information in the target space environment to obtain the target data to be outputted; or, in response to obtaining the instruction information generated by operations acting on the target application, perform at least one process on the first image data to obtain the target data to be outputted; or, perform at least one process on the first image data based on the target space environment information and the resource information of the processing device to obtain the target data to be outputted; or, perform at least one process on the first image data based on configuration information and/or usage information of an output component for outputting the target data to be outputted to obtain the target data to be outputted.

In some embodiments, the processing module 302 may be configured to process a plurality of first audio data obtained based on a control signal into the target audio data, process a plurality of first image data obtained based on the control signal into the target image data, merge the target audio data and the target image data based on the control signal to obtain the target data to be outputted, where the control signal may at least include a signal for triggering the microphone array or the camera array of the processing device to collect corresponding data.

In some embodiments, the processing module 302 may be configured to determine the current use mode of the processing device, and select the target audio data and the target image data from the first audio data and the first image data based at least one the use mode, and perform fusion processing on the target audio data and the target image data based at least one the use mode to obtain the target data to be outputted.

In some embodiments, the processing module 302 may be configured to obtain system resource information of the processing device, determine a target algorithm set from an algorithm library preset by the processing device based on the system resource information, and use an algorithm model in the target algorithm set to perform corresponding processing on the first audio data and/or the first image data to obtain the target data to be outputted. In some embodiments, the algorithm library may be located in the processing device or in the space environment where the processing device is located, and the target algorithm set may be updated correspondingly based on the changes in the system resource information. Alternatively, the processing module 302 may be configured to obtain system resource information of the processing device, optimize the original algorithm model based on the system resource information and use the optimized target algorithm model or target algorithm set to perform corresponding processing on the first audio data and/or the first image data to obtain the target data to be outputted. In some embodiments, the target algorithm set or the target algorithm model may be updated correspondingly based on changes in the system resource information.

In some embodiments, the output module 303 may be configured to output the target data to be outputted to a second target application different from a first target application if the first audio data and/or the first image data includes audio data and/or image data from the first target application, the first target application and the second target application being run on different second electronic devices; or, output the target data to be outputted to a third target application that is identical to the first target application if the first audio data and/or the first image data includes audio data and/or image data from the first target application, the first target application and the third target application being run on different second electronic devices; or, in response to obtaining a sharing request from the first target application, the sharing request including a sharing object of the target data to be outputted, output the target data to be outputted to a fourth target application corresponding to the sharing object, the fourth target application and the first target application being the same or different applications running on different second electronic devices.

In some embodiments, the output module 303 may be further configured to output the target data to be outputted to a target output component, the target output component including an output component of the processing device and/or a display output component and/or an audio output component connected to the processing device. In some embodiments, the target data to be outputted may be output to the target output component and the target space environment through the same or different channels.

A person having ordinary skills in the art can appreciate that various parts of the present disclosure may be implemented using related hardware, computer software, firmware, or a combination thereof. In the above embodiments, multiple steps or methods may be executed by software or firmware stored in the computer-readable storage medium and executable by a suitable instruction-executing system. For example, if the present disclosure is executed by hardware, the hardware may include any of the following technologies known in the art or any combination thereof: a discreet logic circuit of a logic gate circuit configured to perform logic functions for digital signals, an application specific integrated circuit having suitable combinations of logic gate circuits, a programmable gate array (“PGA”), a field programmable gate array (“FPGA”), etc.

A person having ordinary skills in the art can understand that some or all of the steps of the above embodiments of the disclosed method may be implemented by a program instructing relevant hardware. The program may be stored in a computer-readable medium. When executed, the program may include one of the steps or a combination of the steps of the disclosed method. Various functional units may be integrated in a single processing module, or may exist as separate physical units. In some embodiments, two or more units may be integrated in a single module. The integrated module may be executed by hardware or by software functional modules. If the integrated module is executed by software functional modules and sold or used as an independent product, the integrated module may also be stored in a computer-readable storage medium. The storage medium mentioned above may be a read only storage device (e.g., memory), a magnetic disk, or an optical disk, etc.

The processor can be a general-purpose processor, a digital signal processor (DSP), an application specific integrated circuit (ASIC), a programmable logic device (PLD), or a combination thereof. The PLD can be a complex programmable logic device (CPLD), a field-programmable gate array (FPGA), a general array logic GAL), or any combination thereof. The general-purpose processor can be a microprocessor or the processor can also be any conventional processor, etc.

The storage can include non-permanent storage in computer-readable media, random-access memory, and/or non-volatile memory, such as read-only memory (ROM) or flash memory. The memory is an example of a computer readable medium.

The readable storage medium herein may be a magnetic disk, an optical disc, a DVD, a USB, a read-only memory (ROM), a random-access memory (RAM), or the like. The present disclosure does not limit the specific storage medium form.

The above examples are only exemplary embodiments of the present disclosure and are not intended to limit the scope of the disclosure, which is defined by the claims. It is contemplated that various modifications and equivalent replacements may be made to the disclosure within the essence and protection scope thereof, and such modifications and replacements may be regarded as falling in the protection scope of the disclosure.

What is claimed is:

1. A processing method applied to a first electronic device, comprising:
obtaining first audio data and/or first image data;
performing at least one process on the first audio data and/or the first image data to obtain target data to be outputted; and
transmitting the target data to be outputted to a target application running on a second electronic device having a communication connection with the first electronic device, the target application being configured to directly output the target data to be outputted;
wherein data size of the target data to be outputted is different from data size of the first audio data and/or the first image data.

2. The method of claim 1, wherein obtaining the first audio data and/or the first image data includes:
using a microphone array and/or a camera array of the first electronic device to collect audio data and/or image data in a target space environment as the first audio data and/or the first image data; or,
using audio data and/or image data from the target application as the first audio data and/or the first image data; or,
using the audio data and/or the image data in the target space environment collected by the microphone array and/or the camera array of the first electronic device, and the audio data and/or the image data from the target application as the first audio data and/or the first image data; or,
using the audio data and/or the image data in the target space environment collected by the microphone array and/or the camera array of the first electronic device, the audio data and/or the image data from the target application, and audio data and/or image data collected by a third electronic device as the first audio data and/or the first image data;
wherein the target space environment being a space environment where the first electronic device is located, the microphone array and/or the camera array being configured to adjust their collection ranges in the target space environment based on change information in the target space environment, the target application including one application or multiple applications of the same or different types.

3. The method of claim 2, wherein performing at least one process on the first audio data to obtain the target data to be outputted includes:
performing at least one process on the first audio data based on the change information in the target space environment to obtain the target data to be outputted; or,
performing at least one process on the first audio data in response to obtaining instruction information generated by operations acting on the target application to obtain the target data to be outputted; or,
performing at least one process on the first audio data based on target space environment information and resource information of the first electronic device to obtain the target data to be outputted.

4. The method of claim 2, wherein performing at least one process on the first image data to obtain the target data to be outputted includes:
performing at least one process on the first image data based on the change information in the target space environment to obtain the target data to be outputted; or,
performing at least one process on the first image data in response to obtaining instruction information generated by operations acting on the target application to obtain the target data to be outputted; or,
performing at least one process on the first image data based on target space environment information and resource information of the first electronic device to obtain the target data to be outputted; or,
performing at least one process on the first image data based on configuration information and/or usage information of an output component for outputting the target data to be outputted to obtain the target data to be outputted.

5. The method of claim 2, wherein performing at least one process on the first audio data and the first image data to obtain the target data to be outputted includes:
processing a plurality of first audio data obtained through a control signal into target audio data;
processing a plurality of first image data obtained through the control signal into target image data; and
merging the target audio data and the target image data based on the control signal to obtain the target data to be outputted;
wherein the control signal at least including a signal for triggering the microphone array and/or the camera array of the first electronic device to collect corresponding data.

6. The method of claim 2, wherein performing at least one process on the first audio data and the first image data to obtain the target data to be outputted includes:
determining a use mode of the first electronic device; and
selecting target audio data and target image data from the first audio data and the first image data based at least on the use mode, and performing fusion processing on the target audio data and the target image data based at least one the use mode to obtain the target data to be outputted.

7. The method of claim 1, wherein performing at least one process on the first audio data and/or the first image data to obtain the target data to be outputted includes:
obtaining system resource information of the first electronic device, determining a target algorithm set from an algorithm library preset by the first electronic device based on the system resource information, and performing corresponding processing on the first audio data and/or the first image data by using an algorithm model in the target algorithm set to obtain the target data to be outputted, the algorithm library being located in the first electronic device or in the space environment where the first electronic device is ls located, the target algorithm set being updated correspondingly based on changes in the system resource information; or,
obtaining the system resource information of the first electronic device, optimizing an original algorithm model based on the system resource information, and performing the corresponding processing on the first audio data and/or the first image data by using the optimized target algorithm model or the target algorithm set to obtain the target data to be outputted, the target algorithm set or the target algorithm model being updated correspondingly based on changes in the system resource information.

8. The method of claim 2, wherein outputting the target data to be outputted to the target application running on the second electronic device having the communication connection with the first electronic device includes:
if the first audio data and/or the first image data includes audio data and/or image data from a first target application, outputting the target data to be outputted to the second target application different from the first target application, the first target application and the second target application being ran on different second electronic devices; or,
if the first audio data and/or the first image data includes the audio data and/or the image data from the first target application, outputting the target data to be outputted to a third target application identical to the first target application, the first target application and the third target application being ran on different second electronic devices; or,
in response to obtaining sharing request from the first target application, the sharing request including a sharing object of the target data to be outputted, outputting the target data to be outputted to a fourth target application corresponding to the sharing object, the fourth /target application and the first target application being the same or different applications running on different second electronic devices.

9. The method of claim 1 further comprising:
outputting the target data to be outputted to a target output component, the target output component being an output component of the first electronic device and/or a display component and/or an audio output component connected to the first electronic device, wherein:
the target data to be outputted is output to the target output component and the target application through the same or different channels.

10. An electronic device, as a first electronic device, comprising:
a body;
a microphone array arranged on the body for collecting audio data in a target space environment;
a camera array arranged on the body for collecting image data in the target space environment;
a processing disposed in the body, the processing device being configured to:
obtain first audio data and/or first image data, the first audio data including or not including the audio data collected by the microphone array, the first image data including or not including the image data collected by the camera array;
perform at least one process on the first audio data and/or the first image data to obtain target data to be outputted, data size of the target data to be outputted being different from data size of the first audio data and/or the first image data; and
transmit the target data to be outputted to a target application running on a second electronic device having a communication connection with the electronic device, the target application being configured to directly output the target data to be outputted.

11. A processing device comprising:
an acquisition module configured to obtain first audio data and/or first image data;
a processing module configured to perform at least one process on the first audio data and/or the first image data to obtain target data to be outputted; and
an output module configured to transmit the target data to be transmitted to a target application running on a second electronic device having a communication connection with the electronic device, the target application being configured to directly output the target data to be outputted;
wherein data size of the target data to be outputted is different from data size of the first audio data and/or the first image data.

12. The processing device of claim 1, wherein the acquisition module is further configured to:
use a microphone array and/or a camera array of the processing device to collect audio data and/or image data in a target space environment as the first audio data and/or the first image data; or,
use audio data and/or image data from the target application as the first audio data and/or the first image data; or,
use the audio data and/or the image data in the target space environment collected by the microphone array and/or the camera array of the processing device, and the audio data and/or the image data from the target application as the first audio data and/or the first image data; or,
use the audio data and/or the image data in the target space environment collected by the microphone array and/or the camera array of the processing device, the audio data and/or the image data from the target application, and audio data and/or image data collected by a third electronic device as the first audio data and/or the first image data, the target space environment being a space environment where the processing device is located;
wherein the microphone array and/or the camera array are configured to adjust their collection ranges in the target space environment based on change information in the target space environment, the target application including one application or multiple applications of the same or different types.

13. The processing device of claim 12, wherein the processing module is further configured to:
perform at least one process on the first audio data based on the change information in the target space environment to obtain the target data to be outputted; or,
perform at least one process on the first audio data in response to obtaining instruction information generated by operations acting on the target application to obtain the target data to be outputted; or,
perform at least one process on the first audio data based on target space environment information and resource information of the first electronic device to obtain the target data to be outputted.

14. The processing device of claim 12, wherein the processing module is further configured to:
perform at least one process on the first image data based on the change information in the target space environment to obtain the target data to be outputted; or,
perform at least one process on the first image data in response to obtaining instruction information generated by operations acting on the target application to obtain the target data to be outputted; or,
perform at least one process on the first image data based on target space environment information and resource information of the first electronic device to obtain the target data to be outputted; or,
perform at least one process on the first image data based on configuration information and/or usage information of an output component for outputting the target data to be outputted to obtain the target data to be outputted.

15. The processing device of claim 12, wherein the processing module is further configured to:
process a plurality of first audio data obtained through a control signal into target audio data;
process a plurality of first image data obtained through the control signal into target image data; and
merge the target audio data and the target image data based on the control signal to obtain the target data to be outputted, the control signal at least including a signal for triggering the microphone array and/or the camera array of the first electronic device to collect corresponding data.

16. The processing device of claim 12, wherein the processing module is further configured to:
determine a use mode of the process device; and
select target audio data and target image data from the first audio data and the first image data based at least on the use mode, and perform fusion processing on the target audio data and the target image data based at least one the use mode to obtain the target data to be outputted.

17. The processing device of claim 11, wherein the processing module is further configured to:
obtain system resource information of the processing device, determine a target algorithm set from an algorithm library preset by the processing device based on the system resource information, and perform corresponding processing on the first audio data and/or the first image data by using an algorithm model in the target algorithm set to obtain the target data to be outputted, the algorithm library being located in the processing device or in the space environment where the processing device is ls located, the target algorithm set being updated correspondingly based on changes in the system resource information; or,
obtain the system resource information of the processing device, optimize an original algorithm model based on the system resource information, and perform the corresponding processing on the first audio data and/or the first image data by using the optimized target algorithm model or the target algorithm set to obtain the target data to be outputted, the target algorithm set or the target algorithm model being updated correspondingly based on changes in the system resource information.

18. The processing device of claim 12, wherein the output module is further configured to:
if the first audio data and/or the first image data includes audio data and/or image data from a first target application, transmit the target data to be outputted to the second target application different from the first target application, the first target application and the second target application being ran on different second electronic devices; or,
if the first audio data and/or the first image data includes the audio data and/or the image data from the first target application, transmit the target data to be outputted to a third target application identical to the first target application, the first target application and the third target application being ran on different second electronic devices; or,
in response to obtaining sharing request from the first target application, the sharing request including a sharing object of the target data to be outputted, transmit the target data to be outputted to a fourth target application corresponding to the sharing object, the fourth /target application and the first target application being the same or different applications running on different second electronic devices.

19. The processing device of claim 11, wherein the output module is further configured to:
transmit the target data to be outputted to a target output component, the target output component being an output component of the processing device and/or a display component and/or an audio output component connected to the processing device, the target data to be outputted being output to the target output component and the target application through the same or different channels.

20. The processing device of claim 16, wherein:
the use mode of the process device includes at least a whiteboard mode, a speech mode, a comparison mode, a display mode.
